(19) United States
(12) Patent Application Publication
(10) Pub. No.: US 2002/0070471 A1
(43) Pub. Date: Jun. 13, 2002

(54) Method and apparatus for controlling flow in a drum

(76) Inventors: George Lee, Peabody, MA (US); George J. Bontaites JR., Marblehead, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/733,147

(22) Filed: Dec. 8, 2000

Related U.S. Application Data
(60) Provisional application No. 60/170,037, filed on Dec. 10, 1999.

(51) Int. Cl. B29C 47/92; D01D 5/08; D04H 3/02

(52) U.S. Cl. 264/40.3; 264/40.7; 264/555; 264/571; 264/103; 425/72.2; 425/363

(57) ABSTRACT

A method of manufacturing a non-woven material uses a contoured honeycomb drum with an outer microporous surface, more particularly with a contoured outer surface, for the manufacture of contoured non-woven fibrous materials. The method can use spunbonded, melt blown, or electro-static spun techniques for depositing solidifying filaments on the microporous surface such that the non-woven material conforms to the contour of the drum. The drum facilitates continuous production of non-woven articles with three-dimensional shapes such as surgical masks or pleated air filters. Airflow through the drum can be controlled with an internal adjustable manifold with independent valves to obtain non-woven material articles of various configurations and properties. In addition, efficiency can be improved by including turning vanes. Vacuum or pressure can be applied.

### RELATED APPLICATIONS

This application is related to and claims priority to U.S. patent application Ser. No. 60/170,037 entitled “Method and Apparatus for Controlling Flow in a Drum, filed on Dec. 10, 1999, as well as is related to International Patent Application No. PCT/US99/27294 entitled “Method and Apparatus for Manufacturing Non-Woven Articles” filed on Nov. 17, 1999, which in turn claims priority to U.S. patent application Ser. No. 09/193,582, filed Nov. 17, 1998, now U.S. Pat. No. 6,146,580 and U.S. Provisional Patent Application Serial No. 60/149,270, filed Aug. 17, 1999, all the disclosures of which are incorporated herein by reference in their entirety.

### FIELD OF THE INVENTION

This invention relates to a method of using a honeycomb drum with an outer microporous surface to produce non-woven articles and more particularly, to an internal manifold for controlling flow in the drum.

### BACKGROUND OF THE INVENTION

Non-woven materials are used in applications that require articles to be air permeable. Some applications of non-woven articles are surgical masks and filter membranes. Since many applications that use non-woven material entail disposable articles, the non-woven articles should be easily manufacturable and low cost. Some methods of manufacturing non-woven materials are spunbonded and melt blown processes, and electro-spinning of nano-fibers.

FIG. 1 illustrates the spunbonded process 10 for manufacturing non-woven materials. Thermoplastic fiber forming polymer 12 is placed in an extruder 14 and passed through a linear or circular spinneret 16. The extruded liquid polymer streams 18 are rapidly cooled and attenuated by air and/or mechanical drafting rollers 20 to form desired diameter solidifying filaments 22. The solidifying filaments 22 are then laid down on a first conveyor belt 24 to form a web 26. The web 26 is then bonded by rollers 28 to form a spunbonded web 30. The spunbonded web 30 is then transferred by a second conveyer belt 32 and then to a windup 34. The spunbonded process is an integrated one step process which begins with a polymer resin and ends with a finished fabric.

FIG. 2 illustrates the melt blown process 40 for manufacturing non-woven materials. Thermoplastic forming polymer 42 is placed in an extruder 44 and is then passed through a linear die 46 containing about twenty to forty small orifices 48 per inch of die 46 width. Convergent streams of hot air 50 rapidly attenuate the extruded liquid polymer streams 52 to form solidifying filaments 54. The solidifying filaments 54 subsequently get blown by high velocity air 56 onto a take-up screen 58, thus forming a melt blown web 60. The web is then transferred to a windup 62. U.S. Pat. No. 4,380,570 entitled “Apparatus and Process for Melt-Blowing a Fiberforming Thermoplastic Polymer and Product Produced Thereby” describes the melt blown process and is incorporated herein by reference in its entirety.

While non-woven materials can be manufactured by either the spunbonded or melt blown process there are difficulties associated with each process. For example, the newly manufactured non-woven material (e.g. melt blown web 60) tends to stick to the take-up screen 58. Further, the processes produce sheet material. Accordingly, to manufacture non-woven materials into three-dimensional shapes, e.g. surgical masks and pleated filters, some form of post-processing is required.

### SUMMARY OF THE INVENTION

present invention relates to a manifold spanning a sector of a drum across at least a portion of a width thereof, the manifold having at least two chambers independently regulatable with respect to at least one of pressure and flow.

In another embodiment of the present invention, the manifold is an inner tube located inside of a shell, the shell further having at least one plate to prevent airflow from leaking around the inner tube. The inner tube may also include a plurality of ports to provide fluidic communication between the inner tube and the shell. A plurality of gate valves may be provided in communication with the plurality of ports to regulate at least one of pressure in and flow through the manifold.

The shell may include a frame forming an aperture and optionally include a honeycomb panel mounted within the frame aperture. At least one flow turning vane may be disposed between the inner tube and the frame aperture. The shell may include at least one partition, thereby defining the at least two independently regulatable chambers.

Another embodiment of the present invention relates to a drum with a generally tubular honeycomb member that has an outer surface forming a contour. The drum also includes the manifold discussed above, which spans a sector of the drum across a portion of a width thereof. The manifold includes at least two chambers independently regulatable with respect to at least one of pressure and flow. A microporous layer may be provided covering at least a portion of the contour on the outer surface of the drum.

Another embodiment of the present invention relates to a method of independently regulating at least one of pressure and flow spanning a sector of a drum across at least a portion of a width thereof. In one embodiment, the method includes providing a drum with a manifold spanning a sector of the drum across at least a portion of a width thereof. The manifold is subdivided into at least two chambers independently regulatable with respect to at least one of pressure and flow. The method further includes applying a pressure to the manifold to achieve at least one of a desired pressure or flow profile across the sector of the drum. The applied pressure may be negative (i.e., a vacuum) or positive.

Another embodiment of the present invention relates to a method for manufacturing non-woven articles. In one embodiment, the method includes providing a drum made of a tubular honeycomb member that forms an outer contour. The drum also includes the manifold discussed above, which spans a sector of the drum along at least a portion of a width thereof. The manifold is subdivided into at least two chambers independently regulatable with respect to at least one of pressure and flow. The drum may include a microporous layer covering at least a portion of the outer contour.

In accordance with the inventions embodied in a manufacturing system, flows can be tailored to suit the particular contoured articles being formed or to normalize flows across the drum to compensate for inherent variability in conventional vacuum systems.

### BRIEF DESCRIPTION OF THE DRAWINGS

The above and further advantages of this invention may be better understood by referring to the following description, taken in conjunction with the accompanying drawings, in which:

FIG. 1 is a schematic of a spunbonded process for manufacturing non-woven materials;

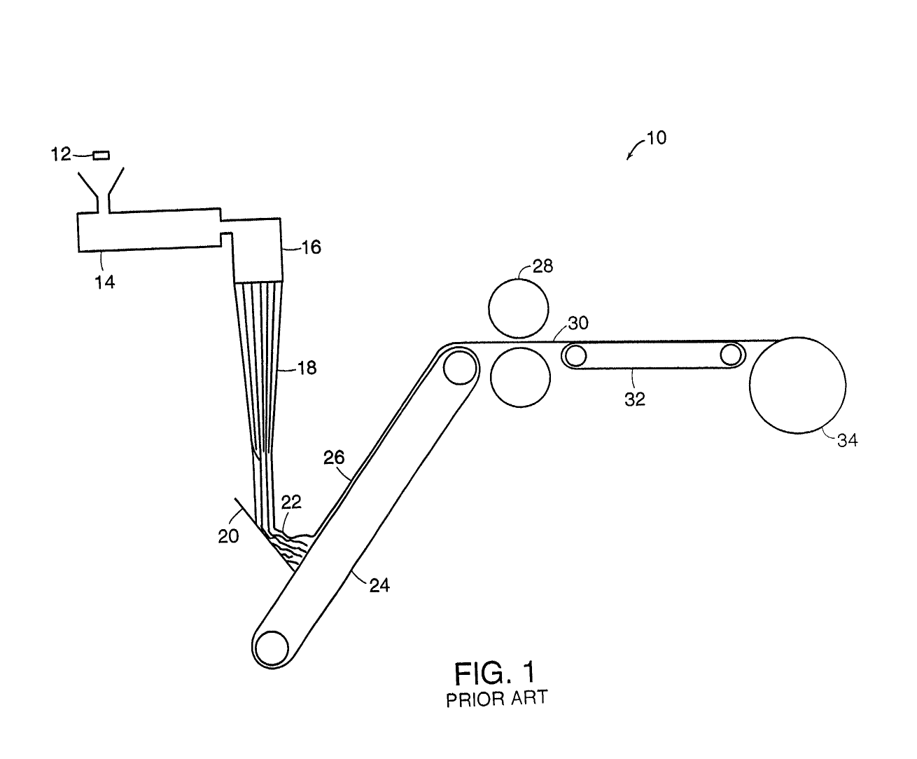

FIG. 2 is a schematic of a melt blown process for manufacturing non-woven materials;

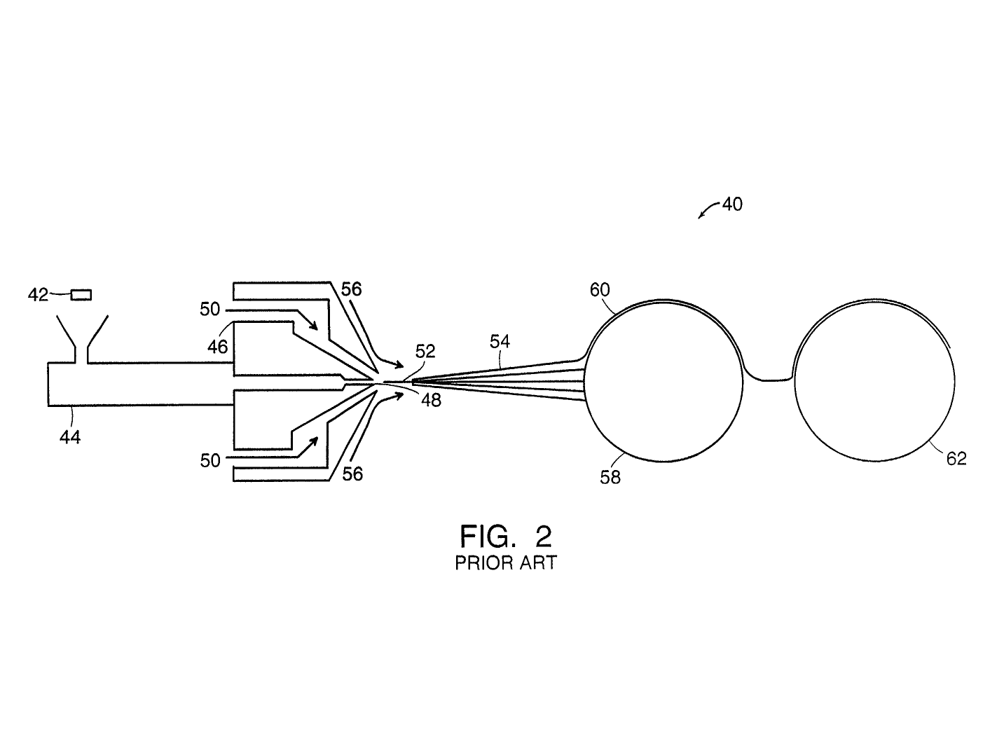

FIG. 3A is a perspective view of an embodiment of the drum of the current invention, illustrating a contoured honeycomb tube with an outer microporous surface;

FIG. 3B is a partially exploded side view of the drum illustrating the mounting structure, vacuum apparatus, and V-belt drive groove;

FIG. 3C is a partially exploded perspective view of the drum structure;

FIG. 4 is a partial cross-sectional view of the drum taken along line 4-4 in FIG. 3A illustrating a pleated surface;

FIG. 5 is a partial radial view of the drum illustrating the honeycomb mesh;

FIG. 6 is a cross-sectional view of the drum taken along line 6-6 in FIG. 3A illustrating a contoured outer surface having a three dimensional surface;

FIG. 7 is a schematic of a process of the current invention for the manufacture of non-woven materials that substantially match the contoured outer surface of the drum;

FIG. 8 is a schematic of a process of the current invention for the post processing of non-woven materials after a three dimensional contour has been formed;

FIG. 9 is a schematic perspective view illustrating a first material and a second material bridging a three dimensional contour;

FIGS. 10A-10C are schematic perspective views illustrating three embodiments of three dimensional shapes that can be formed in a non-woven material by a process of the current invention;

FIG. 11 is a schematic perspective view of a drum apparatus for the manufacture of non-woven materials;

FIG. 12 is a schematic perspective view of an outer drum sector and an inner vacuum tube assembly or manifold of the current invention;

FIG. 13 is a schematic perspective view of an inner tube and a vacuum shell of the manifold of the current invention;

FIG. 14 is a schematic top view of a vacuum frame of the inner tube and vacuum shell depicted in FIG. 13;

FIG. 15 is a partial cross-sectional view of the vacuum tube assembly taken along line 15-15 in FIG. 14;

FIG. 16 is a cross-sectional view of the inner tube and vacuum shell taken along line 16-16 in FIG. 15;

FIG. 17 is an exploded view of Detail C in FIG. 15;

FIG. 18 is a schematic bottom view of an inner tube of the manifold;

FIG. 19 is a schematic side view of the inner tube of the manifold;

FIG. 20 is a partial cross-sectional view of the inner tube taken along line 20-20 in FIG. 19.

FIG. 21 is a schematic perspective view of vanes for controlling air flow direction in the manifold;

FIG. 22 is a schematic side view of the shell and inner tube showing the orientation of the vanes for controlling air flow direction in the manifold;

FIG. 23 is a schematic perspective view of one set of vanes installed in the manifold; and

FIG. 24 is a schematic exploded view of the inner tube, the vacuum shell, the vanes, the frame, the brackets, and the honeycomb of the manifold.

### DETAILED DESCRIPTION OF THE INVENTION

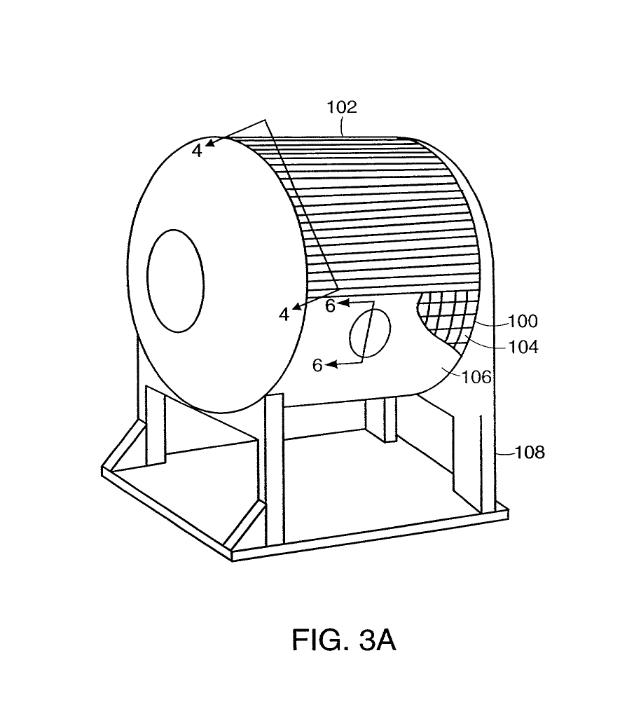

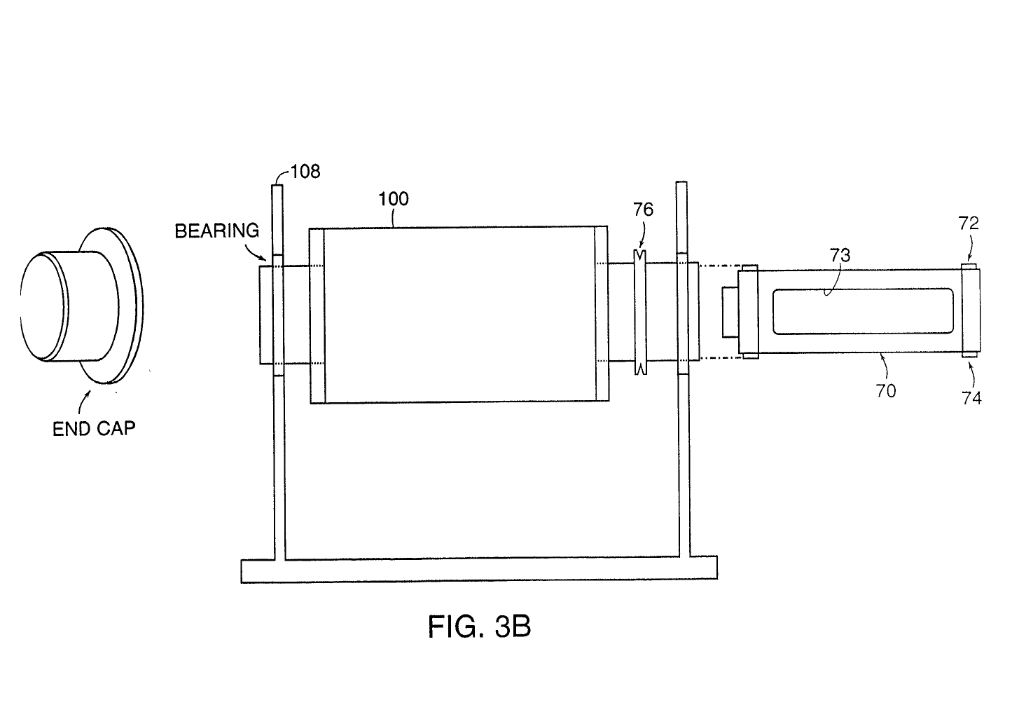

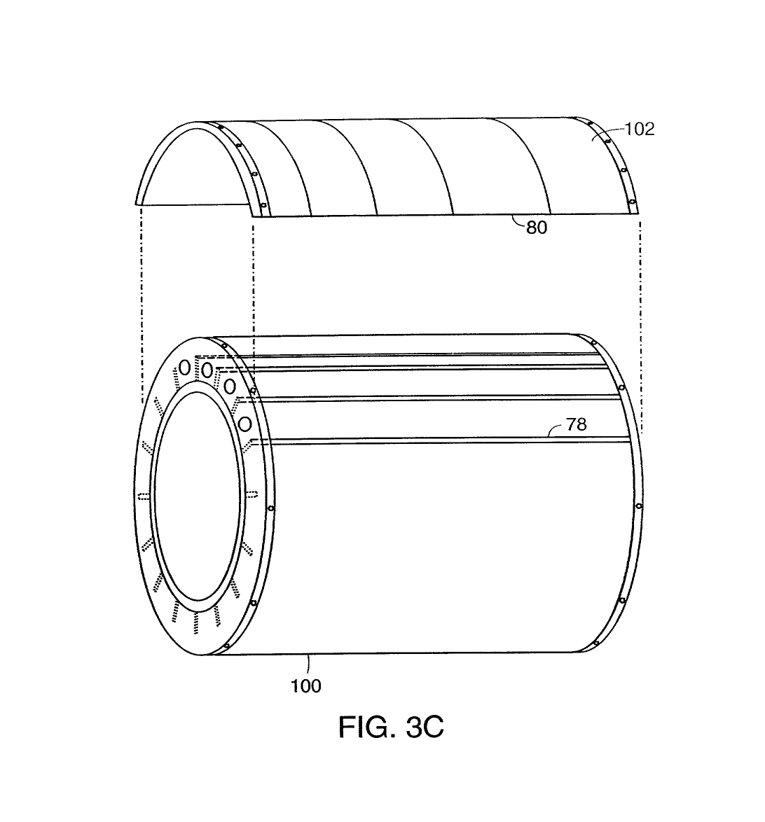

Referring to FIG. 3A, shown is a drum 100 having a contoured outer surface 102 which may take many different shapes and forms. As shown, the drum 100 is made of a tubular honeycomb member 104 that is surrounded by a microporous layer 106. The microporous layer 106 is tack welded to the tubular honeycomb member 104 and may be finely electroetched stainless steel having numerous holes on the order of about 0.010 inches (0.25 mm) in diameter, at a spacing such that the microporous layer 106 is uniformly about fifty percent open. A frame 108 rotatably supports the drum 100. The material for the tubular honeycomb member 104 can be, but is not limited to, stainless steel.

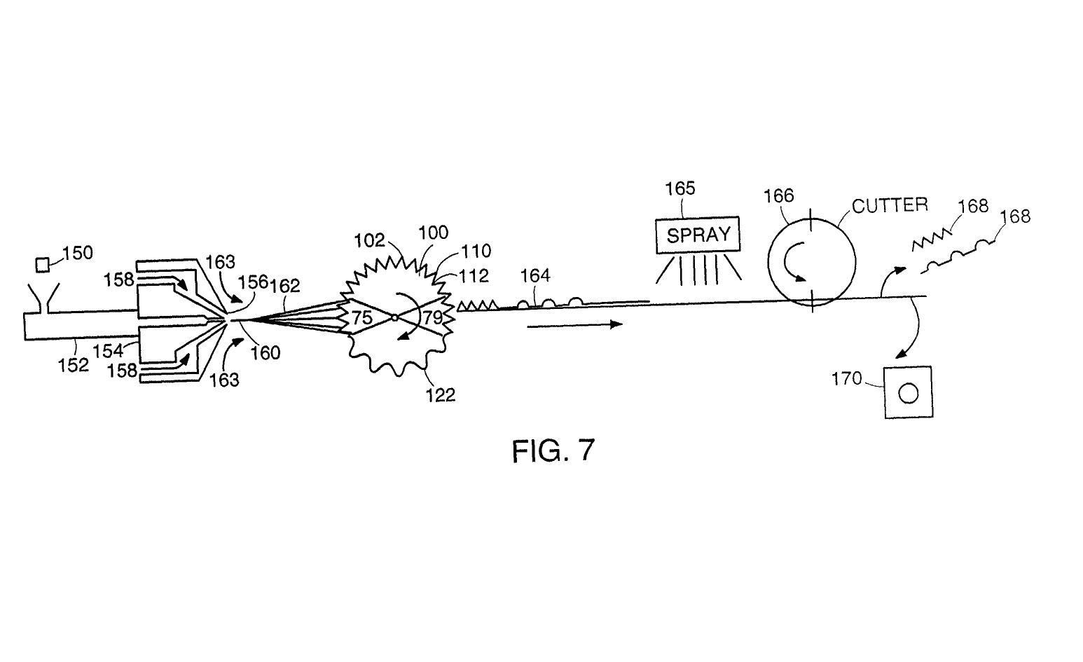

Referring to FIG. 3B, the drum 100 is supported by the frame 108 or frames, so that the drum 100 can be rotated as the solidifying filaments are continuously applied by spunbonded or melt blown processes or by electro-spinning of nano-fibers. FIG. 3B also shows an internal pipe 70 with a vacuum port 72 and a bearing surface 74. The pipe 70 is located in the center of the drum 100. The pipe 70 also has a slot 73 that is in communication with the vacuum port 72 to draw a negative pressure 75 through a sector of the drum 100 to conform the solidifying filaments to the contour. See FIG. 7. Also shown is V-belt drive 76 which can be used to rotate the drum 100 by any conventional source known to those skilled in the art, such as a variable speed motor.

Referring to FIG. 3C, the drum 100 includes inner support bars 78 which are located throughout the drum 100. The inner support bars 78 provide stiffness to the drum 100 and allow a negative pressure 75 or positive pressure 79 to be provided to a portion of the drum 100, as shown in FIG. 7. FIG. 3C also shows that the drum 100 includes a plurality of panels 80 that can attached to the drum 100 by a variety of means (e.g., fasteners or clips). The panels 80 can be made of honeycomb with a microporous outerlayer to form any desired contoured outer surface 102.

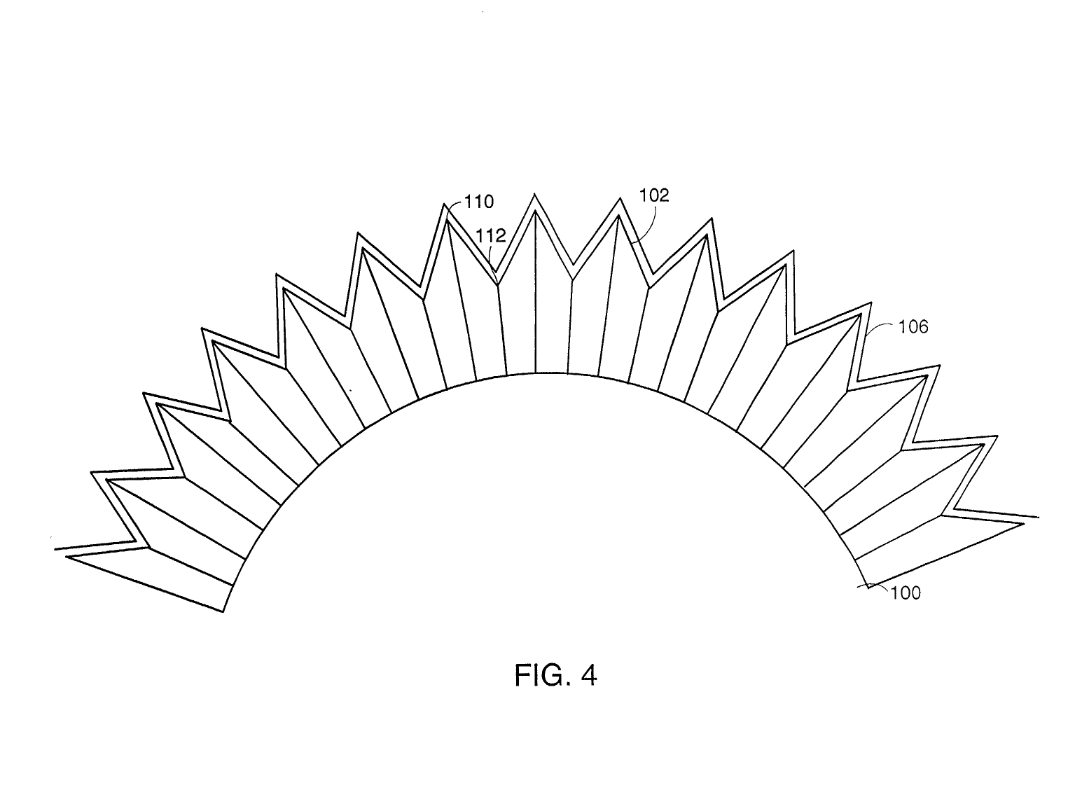

Referring to FIG. 4, shown is a partial cross-sectional view of one embodiment of the drum 100 of the present invention. The drum 100 has a contoured outer surface 102 that has the shape of alternating peaks 110 and valleys 112. The contoured outer surface 102 is covered by the microporous layer 106. As will be further shown, the contoured outer surface 102 with alternating peaks 110 and valleys 112 can be used to form pleated-shaped non-woven articles useful as particulate air filters.

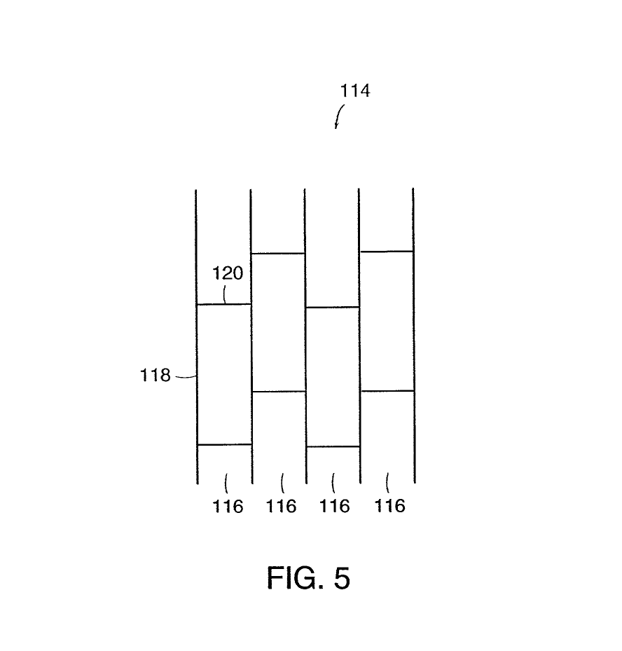

Referring to FIG. 5, shown is a partial radial view of a portion of the drum 100 illustrating a rectangular mesh 114 of tubular honeycomb member 104. The mesh 114 consists of alternating multiple rows of mesh holes 116, where each row is offset from the previous row. Each mesh hole has a length 118 and width 120. In one embodiment the mesh hole length 118 is about 0.5 inches (1.3 cm) and the width 120 is about 0.25 inches (0.64 cm). By using a rectangular mesh 114, the honeycomb member 104 can be readily formed into a circular contour.

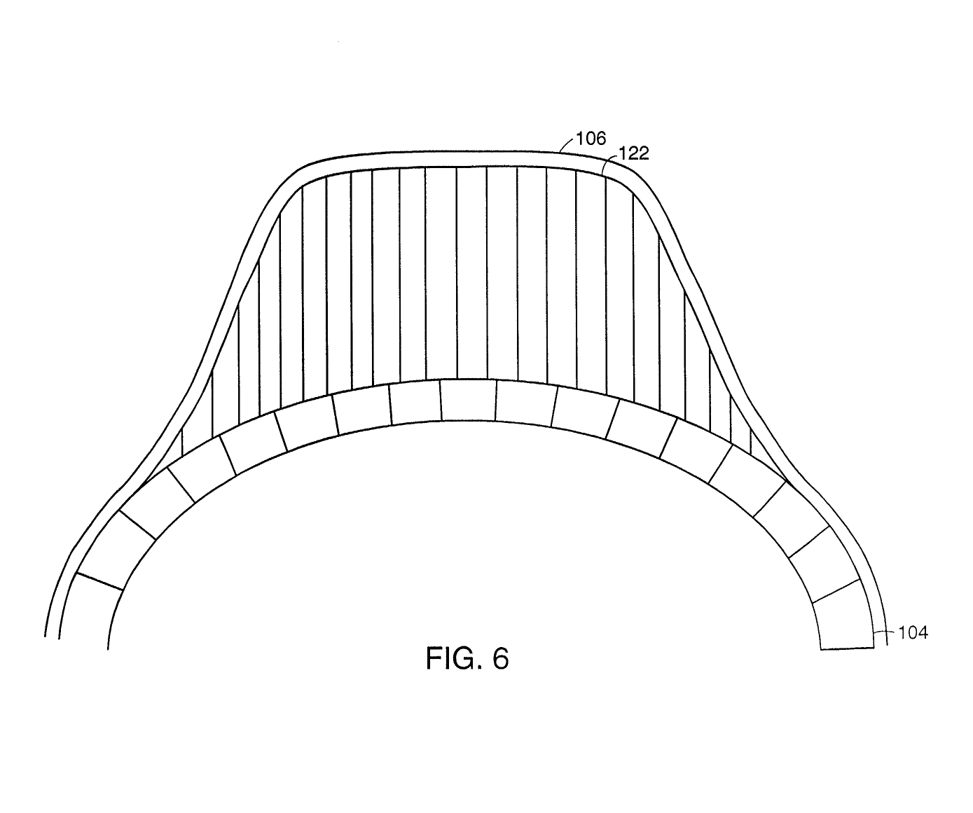

Referring to FIG. 6, shown is another partial cross-sectional view of the drum 100 illustrating a three dimensional form 122 that is attached (e.g., tack-welded) to the drum 100. The three-dimensional form 122 also has honeycomb construction and can be formed by, but not limited to, electrical discharge machining. The three-dimensional form 122 is also covered by the microporous layer 106. As will be further shown, the three-dimensional form 122 can be used to make, for example, a surgical mask shaped article.

FIG. 7 shows one process for manufacturing contoured non-woven articles. Thermoplastic forming polymer 150 is placed in an extruder 152 and passed through a linear die 154 containing about twenty to forty or more small orifices 156 per inch of die 154 width. Convergent streams of hot air 158 rapidly attenuate the extruded liquid polymer 160 to form solidifying filaments 162. The solidifying filaments 162 subsequently get blown by high velocity air 163 onto the contoured outer surface 102 of drum 100. Note that the method illustrated in FIG. 7 for generating the solidifying filaments 162 is a melt blown process, but a spunbonded process, or any other method for generating the solidifying filaments 162 can be used, such as electro-spinning of nano-fibers using an electrostatic spun technique. Melt blown process equipment is available from Biax Fiberfilm Corporation located in Wisconsin.

The drum 100, which is rotating, has a contoured outer surface 102, which can have a combination of shapes, for example, alternating peaks 110 and valleys 112 or a series of three dimensional forms 122. Once the solidifying filaments 162 are deposited on the drum 100, a vacuum or negative pressure 75 can be applied to a portion of the drum 100 to conform the solidifying filaments 162 to the contoured outer surface 102, to prepare closely matching contoured non-woven materials 164.

After the contoured non-woven materials 164 are formed, the rotating drum 100 rotates to a point where the contoured non-woven materials 164 are removed from the drum 100. Positive pressure 79 can optionally be applied through a portion of the drum 100 to facilitate removing the contoured non-woven materials 164 from the drum 100. Once off the drum 100, the contoured non-woven material 164 can be post processed in a variety of post processing operations, for example by application of a spray 165. The treatment can consist of adding various supplements such as flame retardants, stain repellents, colored dyes, and the like, or to change the shape, feel, texture, or appearance of the contoured non-woven material 164.

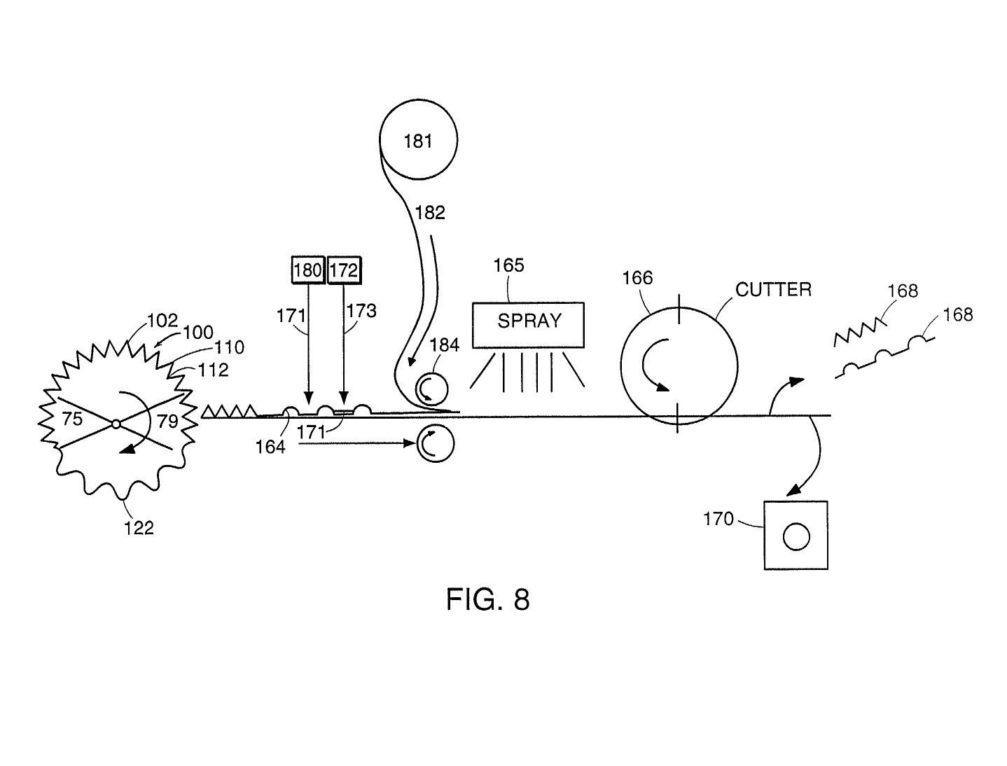

FIG. 8 is an expanded view of additional optional post processing performed on the contoured non-woven material 164. In addition to the treatment operations discussed above, a first material 171 may be added to the contoured non-woven material 164 in order to achieve desired properties in a final product 168. The first material 171 may be a non-woven material or any other material, based on properties required in the final product 168. For example, some materials that can be used for the first material 171 are absorbent substances or charcoal or other filter materials known to those skilled in the art. The first material 171 may be selected based on desired material properties such as pore size, fiber diameter and length, basis weight, and density.

FIG. 8 shows a process step 180 for adding the first material 171 to the contoured non-woven material 164. The process 180 for adding the first material 171 to the contoured non-woven material 164 may be a spunbonded process or a melt blown process for non-woven materials. Alternatively, loose fill or pre-formed sheet goods, with or without an adhesive treatment, can be deposited on the non-woven material 164. If the first material 171 is a material other than a non-woven material, a person skilled in the art can choose the appropriate method for manufacturing the desired material. An additional process 172 can add a second different material 173 on top of the first material 171. The same considerations used to select the first material 171 can be used to select the second material 173.

A covering material 182 from a source 181 may be placed over the contoured non-woven material 164. The covering material 182 captures or retains the first material 171 and the optional second material 173 within the contoured non-woven material 164. Some materials that may be used for the covering material 182 are organic fibers, inorganic fibers, and polymers, which can be in the form of woven or non-woven sheet goods, films, and the like, and which may or may not be porous. The covering material 182 may be adhered or bonded to the contoured non-woven material 164 by a variety of processes 184 known to those skilled in the art, such as a pair of rollers, a heated die, etc. to seal and/or laminate the layers. Additional layers of materials and coverings may be applied, as desired.

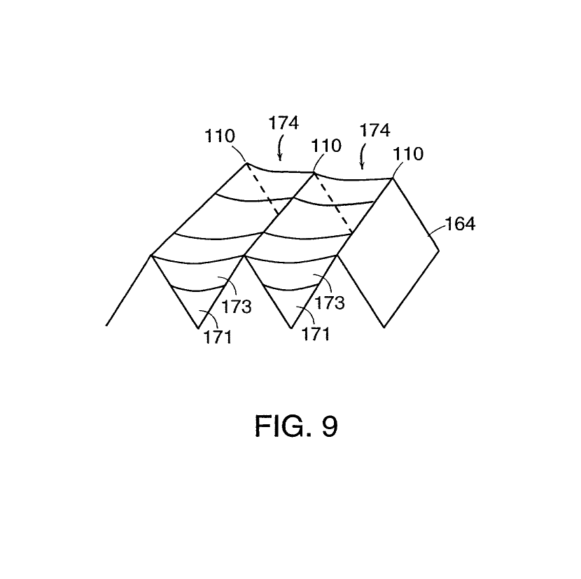

FIG. 9 illustrates the presence of the first material 171 and the second material 173 in the valleys of a pleated contoured non-woven material 164. The first material 171 and the second material 173 effectively bridge 174 the peaks 110 in the pleated material 164. The bridge 174 may be made up of just the first material 171, a combination of the first material 171 and the second material 173, or a plurality of different desired materials. The bridge 174 may bridge or partially or fully fill any three dimensional contour.

The process of FIG. 8 results in a wide variety of articles which can be used in a variety of applications. One embodiment resulting from the process of FIG. 8 consists of a non-woven material 164, where the first material 171 added is a carbon filtration material and a covering material is applied overall. Another embodiment consists of a non-woven material 164, where the material added results in a varying gradient filter article. The varying gradient filter article has multiple filter layers, each layer can have its own filter pore size. Each layer in the varying gradient filter article can trap different particle sizes. In addition, another embodiment of the process of FIG. 8 consists of a non-woven material 164, where the first material 171 added can be a high loft material, so that the resultant article can be used for absorption of oil or other liquid. Other materials can be selected by a person skilled in the art, based on the particular application and performance sought.

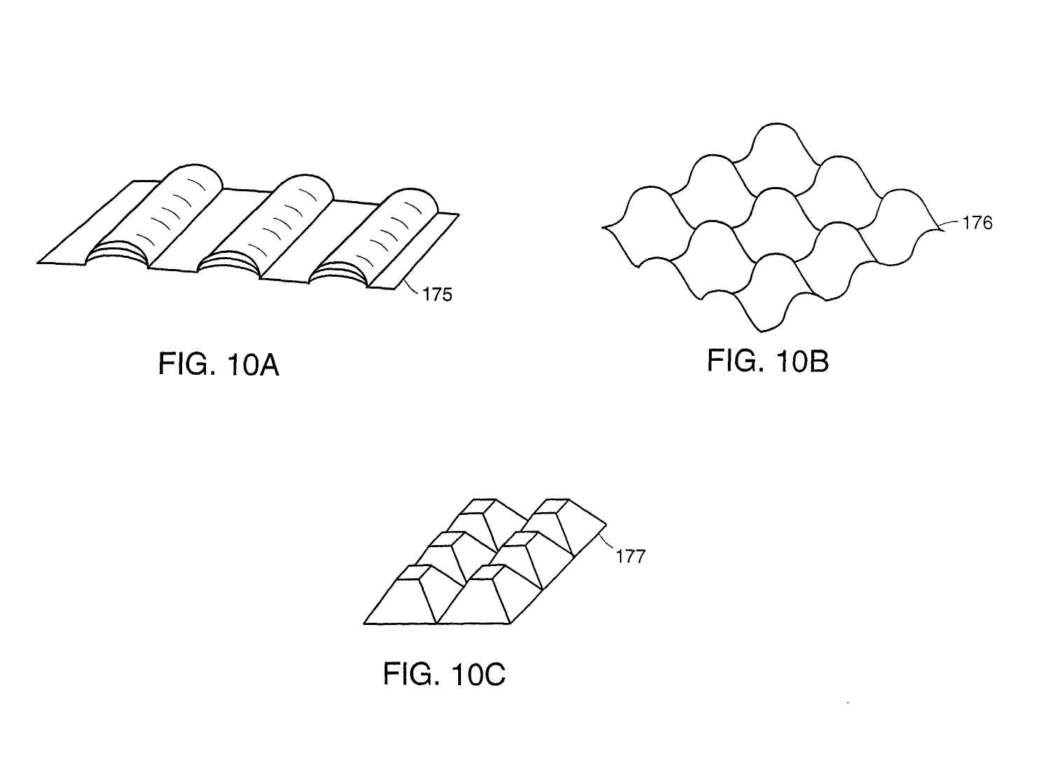

FIGS. 10A-10C show additional three dimensional contours which can be manufactured by the process, such as half tube 175, multinodal 176, and pyramidal or frustoconical 177 contours. Other contours, both regular and irregular, will be apparent to those skilled in the art based on the teachings herein.

Referring back to FIG. 7, after any post processing has been completed, the contoured non-woven material 164 may pass through a cutter 166, to cut the contoured non-woven material 164 into the desired article or final product 168. The cutter 166 may be a die, water jet, laser, or any other apparatus capable of trimming to the desired contour. Any waste 170 after the cutting operation can either be disposed of or recycled. Accordingly, non-woven contoured articles such as wipes, filters, face masks, sorbent products, insulation, clothing, and the like can be rapidly produced from polypropylene, polyester, or other materials in a continuous process at low cost.

While an open, apertured inner tube 70, such as that depicted in FIG. 3B, may be used in a variety of applications with good results, it may be desirable to better control the pressure and/or flow across the drum 100 by using an internal manifold with adjustable features and low losses. Accordingly, the amount of suction or pressure applied to the material deposited on the drum can be tailored for the particular material, density, contour, etc.

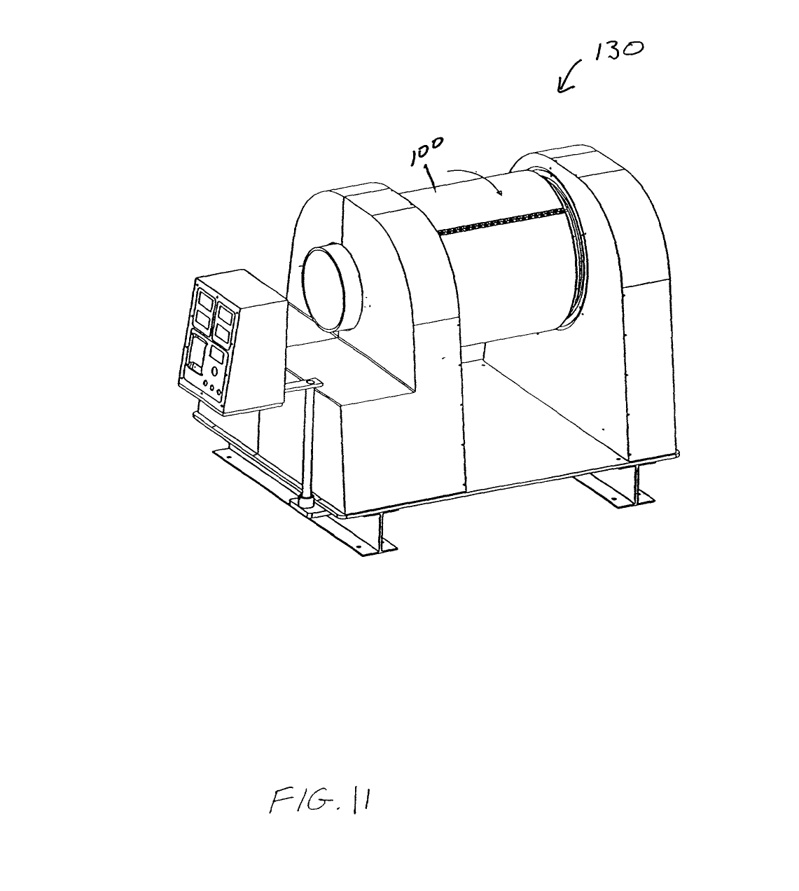

Referring to FIG. 11, shown is an embodiment of an apparatus 130 for the manufacture of non-woven articles. The apparatus 130 includes a rotatable honeycomb drum 100. The drum 100 can have a contoured surface, as discussed hereinabove, and have an adjustable manifold disposed therein.

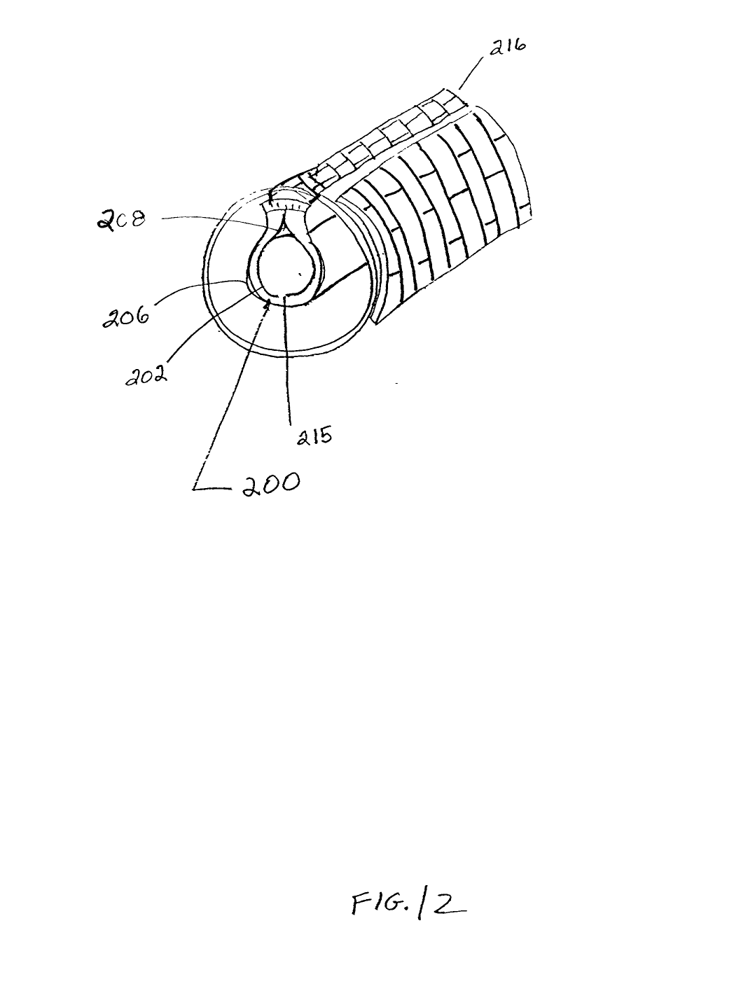

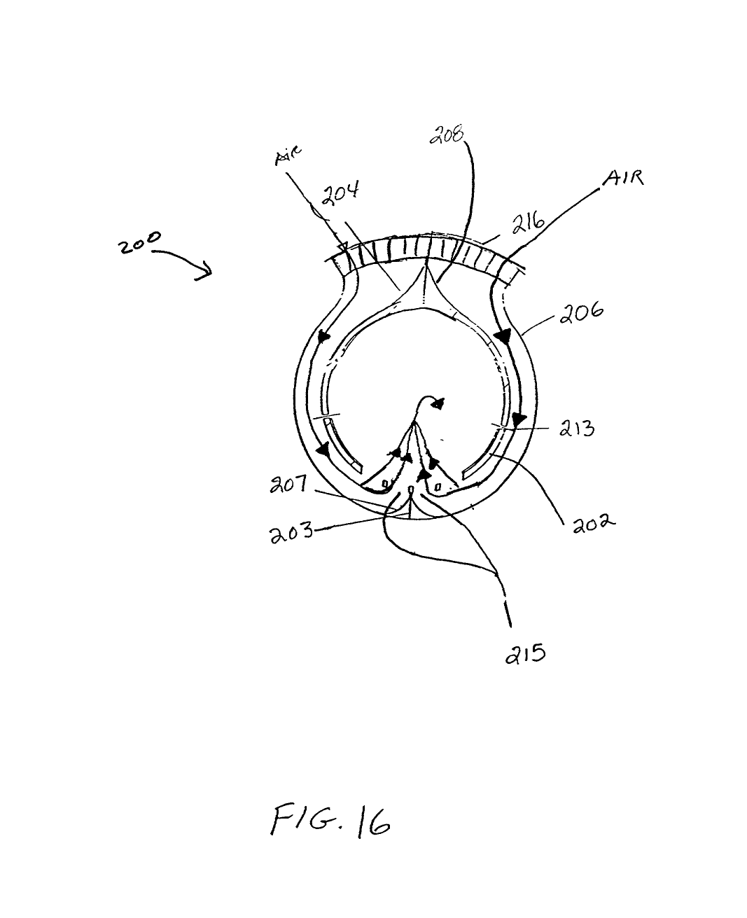

Referring to FIG. 12, shown is an embodiment of a manifold tube assembly 200 for controlling flow in the drum 100, solely a portion of which is depicted. The tube assembly 200 includes an inner tube 202 and a vacuum shell 206. Either vacuum or pressure may be applied to the drum 100. The tube assembly 200 defines an air flow path inside the drum 100. The air flow path passes through a honeycomb panel 216, past a partition top 208, along a channel formed between the inner tube 202 and the vacuum shell 206, through port 215, and inner tube 202. See FIG. 16. Air may flow into or out of the manifold 200 and the drum 100 along the flow path defined above, depending on whether vacuum or pressure is applied to the inner tube 202.

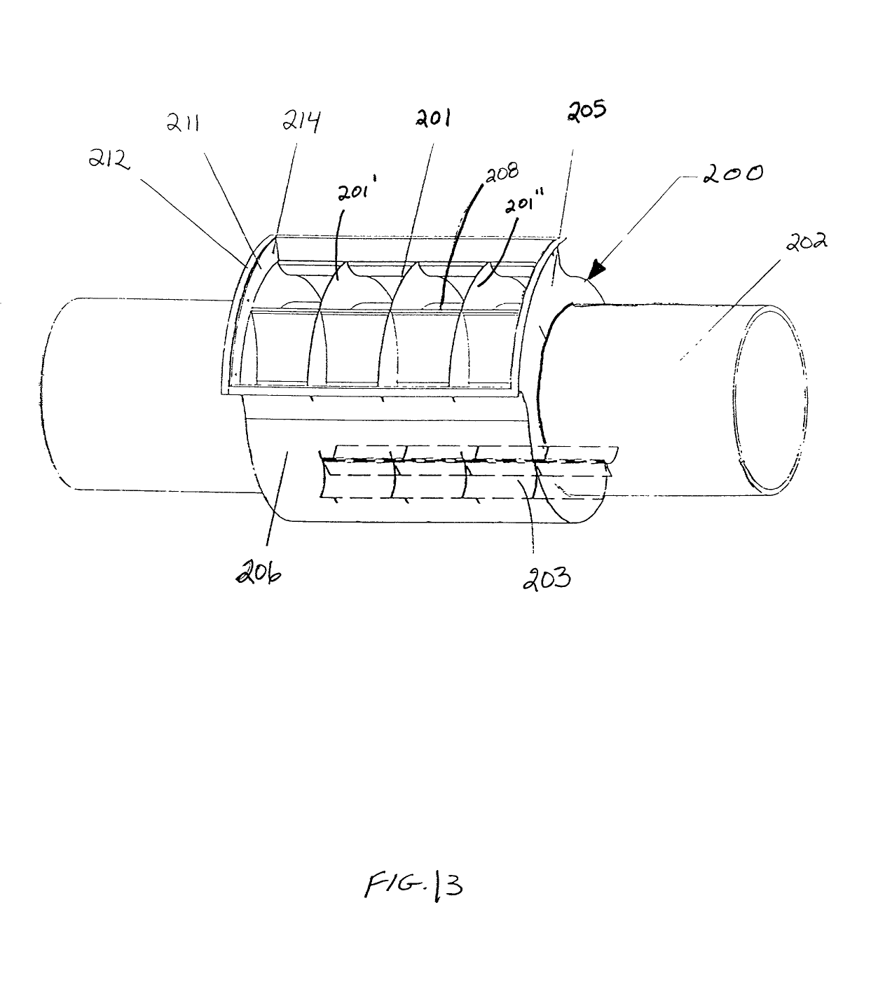

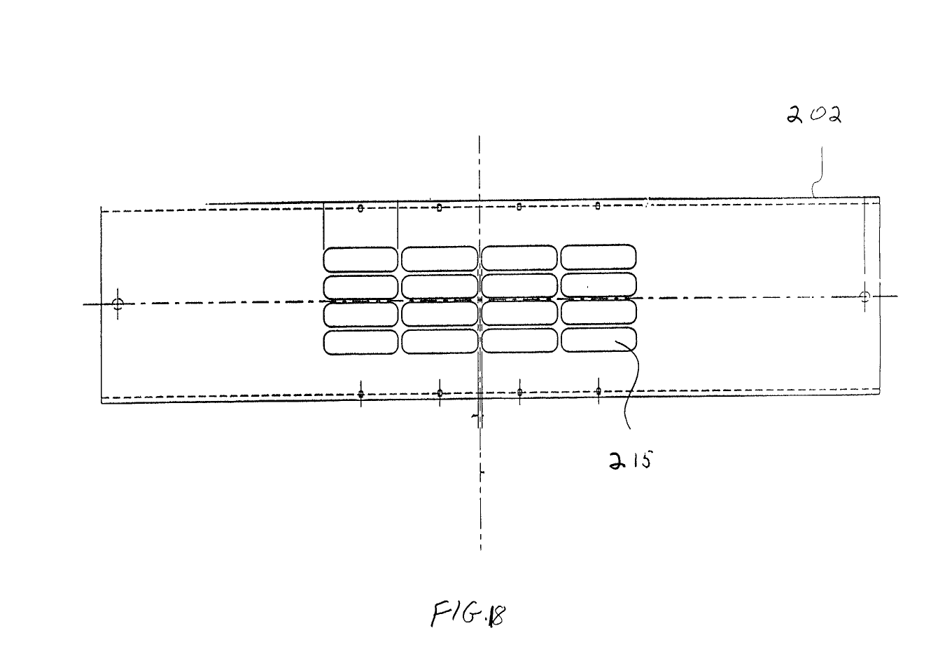

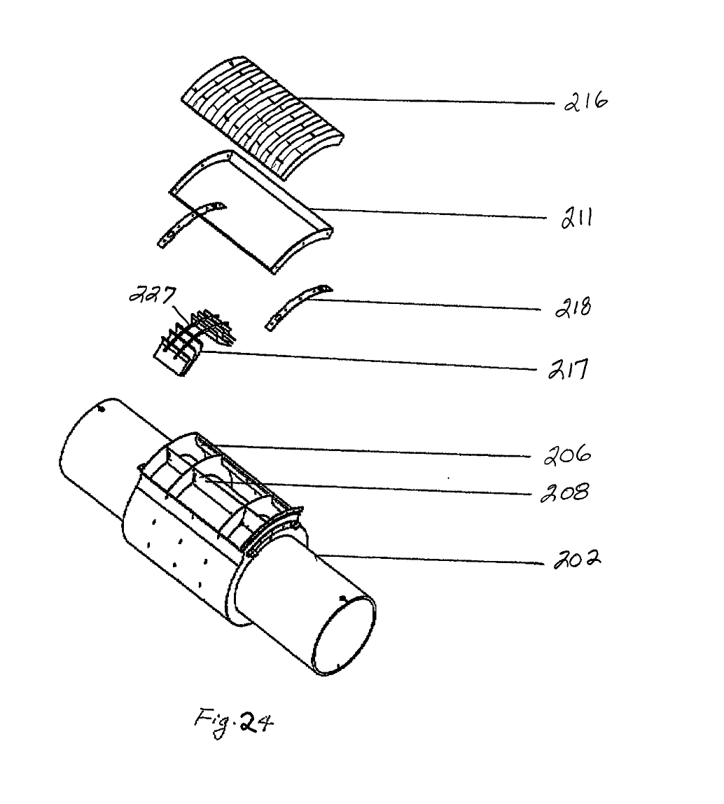

Referring to FIG. 13, shown is a perspective view of an embodiment of the inner tube 202 and vacuum shell 206 of the manifold 200. The inner tube 202 passes through the vacuum shell 206. The vacuum shell 206 has a partitioned bottom 203 to direct air through a plurality of ports 215 of inner tube 202 to allow air to pass into or out of the inner tube 202. See FIG. 18. The vacuum shell 216 includes a vacuum plate 205 at each end sealed to the inner tube 202 to prevent air from leaking around the inner tube 202. A honeycomb panel 216 can be mounted within vacuum frame 211, as shown in FIG. 24, to provide a uniform distribution of air flow through the vacuum shell 206.

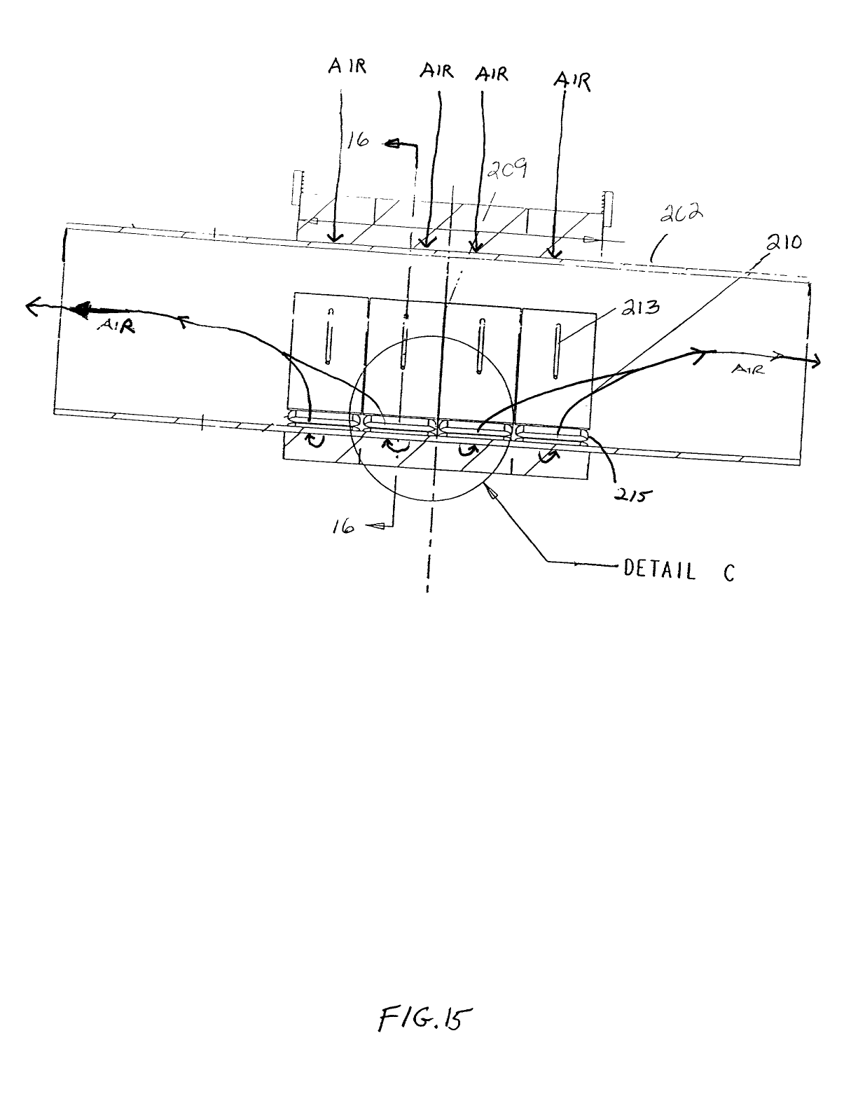

FIG. 13 shows the vacuum shell 206 is split into left and right halves by a center ring partition 201 and along its longitudinal axis by top partition 208 and bottom partition 203. FIG. 15 shows each side or half can be balanced for airflow via a plurality of gate valves 210, which can be adjusted independently to uncover, partially cover, or fully cover the ports 215. The double tube arrangement (inner tube 202 within vacuum shell 206) is used to provide tailored airflow without the use of a plurality of separate pipes. The double tube configuration of the manifold 200 also provides an efficient method for redirecting airflow from a radial to an axial direction.

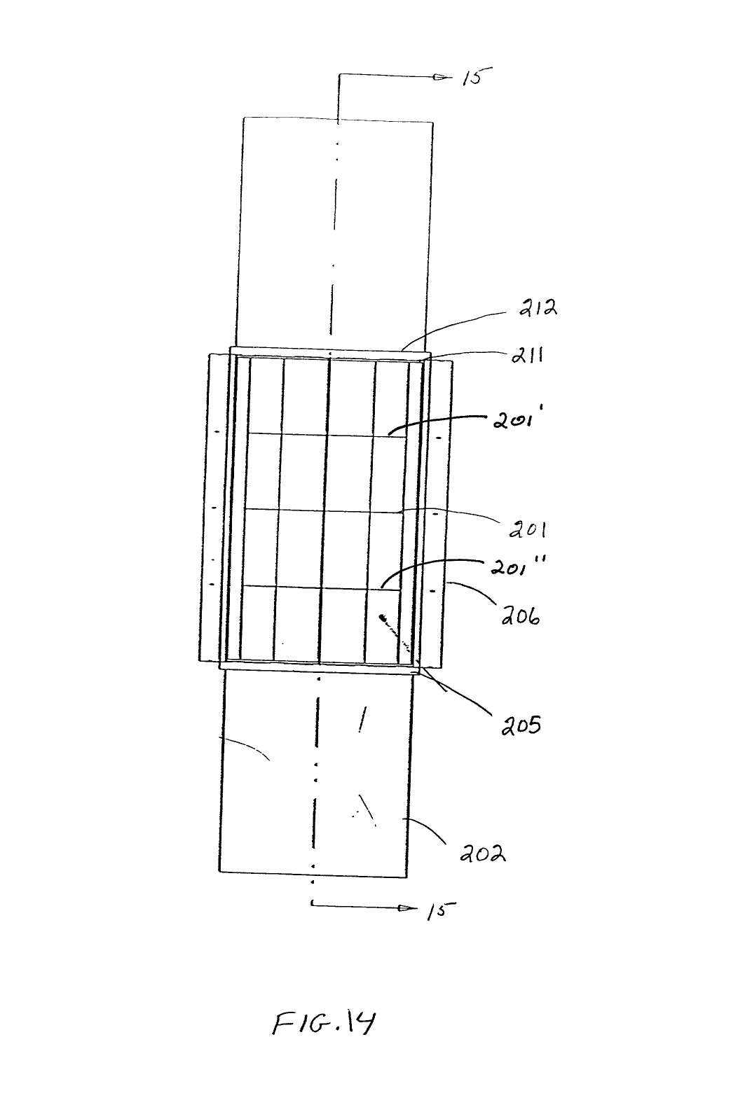

FIG. 14 shows a view of the inner tube 202 and vacuum shell 206 viewed through the vacuum frame 211. This view illustrates the center ring 201 for dividing the air flow at a midpoint of the inner tube 202 and the drum 100. Two additional rings 201′, 201″ are depicted which further subdivide the vacuum frame opening into eighths.

Referring to FIG. 15, shown is a partial cross-sectional view of the inner tube taken along line 15-15 in FIG. 14. FIG. 15 illustrates one embodiment for controlling the flow of air in the drum. Gates 210 can be moved over ports 215 to modify the flow of air into or out of inner tube 202. In one embodiment, the gates 210 are slotted and can be attached to the inner tube 202 by screws 213.

Referring to FIG. 16, shown is a partial cross-sectional view of the inner tube 202 and vacuum shell 206 along line 16-16 in FIG. 15. FIG. 16 illustrates the flow path of air drawn through the drum 100 and into the manifold 200. For descriptive purposes only, a vacuum flow through the drum is described, but the path can be reversed to apply a pressure to the drum to facilitate removing a non-woven article formed thereon. Air is drawn through the outer drum honeycomb assembly (not shown), through the honeycomb panel 216, into an annular channel formed between the vacuum shell 206 and the inner tube 202, and then into the inner tube 202 through ports 215. FIG. 16 also shows once the air is in the inner tube 202, air is drawn out of the inner tube through one or more openings at the ends of the inner tube 202.

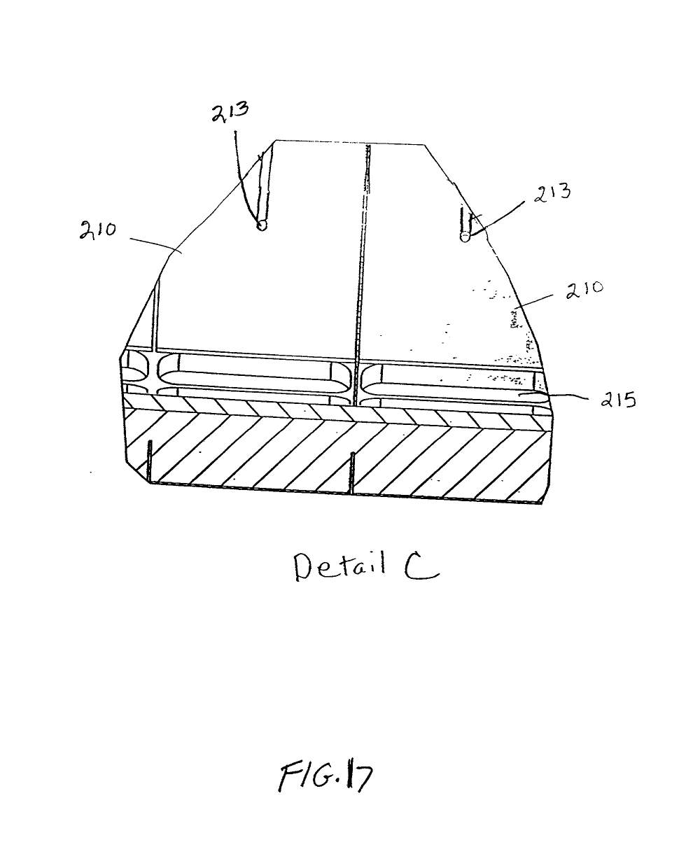

FIG. 17 is an exploded view of Detail C in FIG. 15 to illustrate the relationship between the ports 215, gates 210, and screws 213. As may be readily understood, by subdividing the vacuum tube assembly into a plurality of zones, with airflow paths independently controllable using the gates 210, vacuum or pressure applied to various zones of the drum passing thereover can be tailored to achieve a desired result.

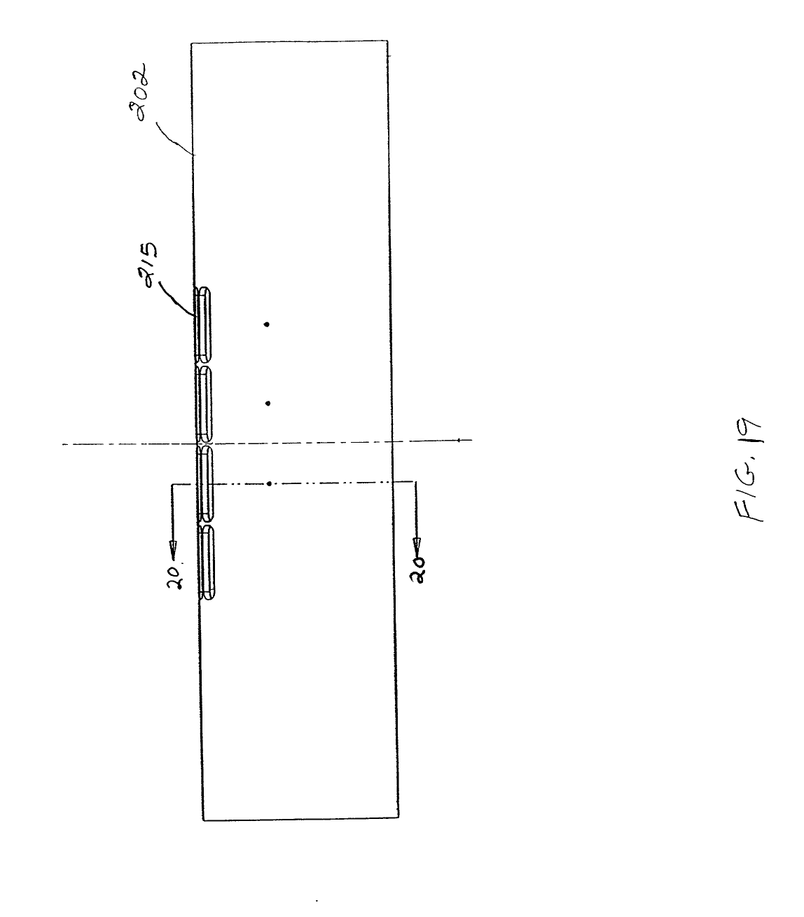

FIG. 18 is a bottom view of the inner tube 202 showing the ports 215 in the inner tube 202 which allow air to pass into or out of the inner tube 202. This embodiment employs sixteen ports 215. FIG. 19 is a side view of inner tube 202.

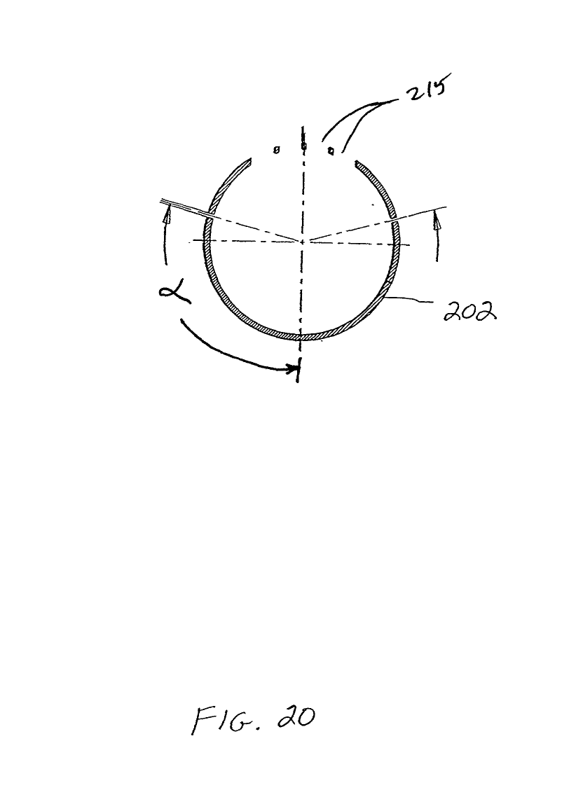

Referring to FIG. 20, shown is a view along cross-section 20-20 of the inner tube 202 of FIG. 19. Topped holes for the gate screws 213 may be located for convenient access to facilitate adjustment of the gates 210. In this embodiment, they may be located at an angle of about 100° to about 110°, although any location can be selected.

Referring back to FIG. 13, the vacuum shell 206 is split into left and right halves by a center ring portion 201 and along its longitudinal axis by top partition 208 and bottom partition 203. FIG. 13 shows an embodiment where the vacuum shell 206 is divided by similar rings 201′, 201″ which are parallel to the outer ring further subdividing the shell 206 into multiple compartments. In this embodiment, there are eight compartments so formed. Each compartment can be balanced for airflow volume via a separate gate valve 210 which can be adjusted to uncover, partially cover, or fully cover two ports 215. In addition, the efficiency of airflow in each compartment can be enhanced and losses reduced by using optional flow turning vanes 217.

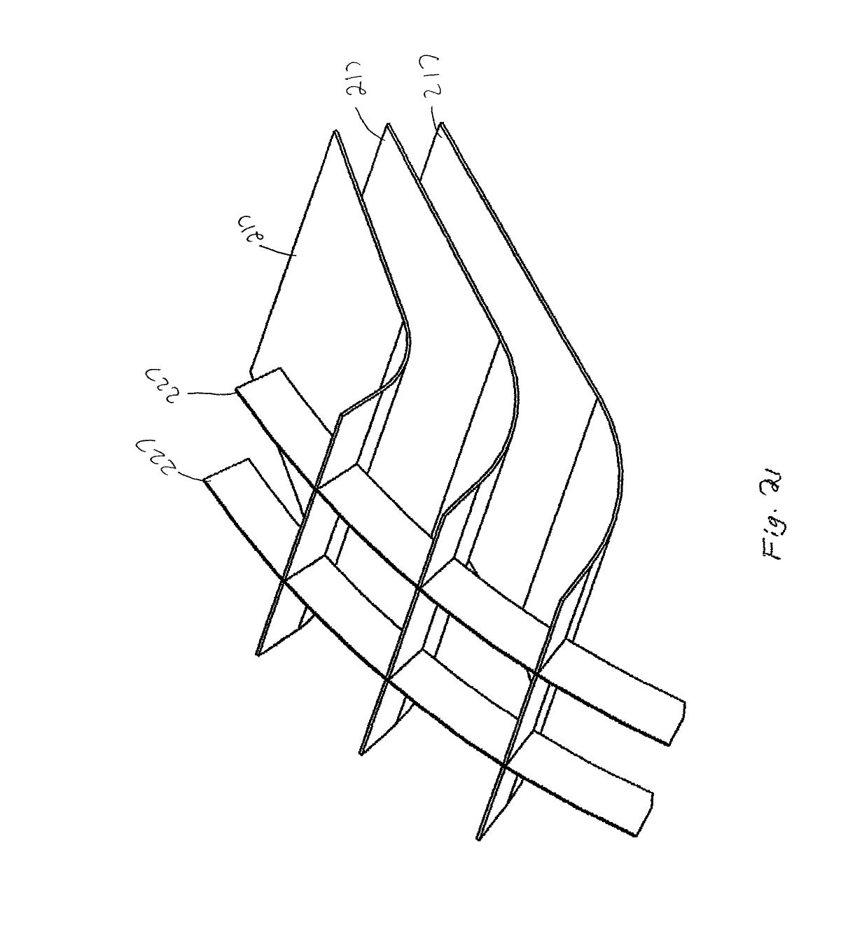

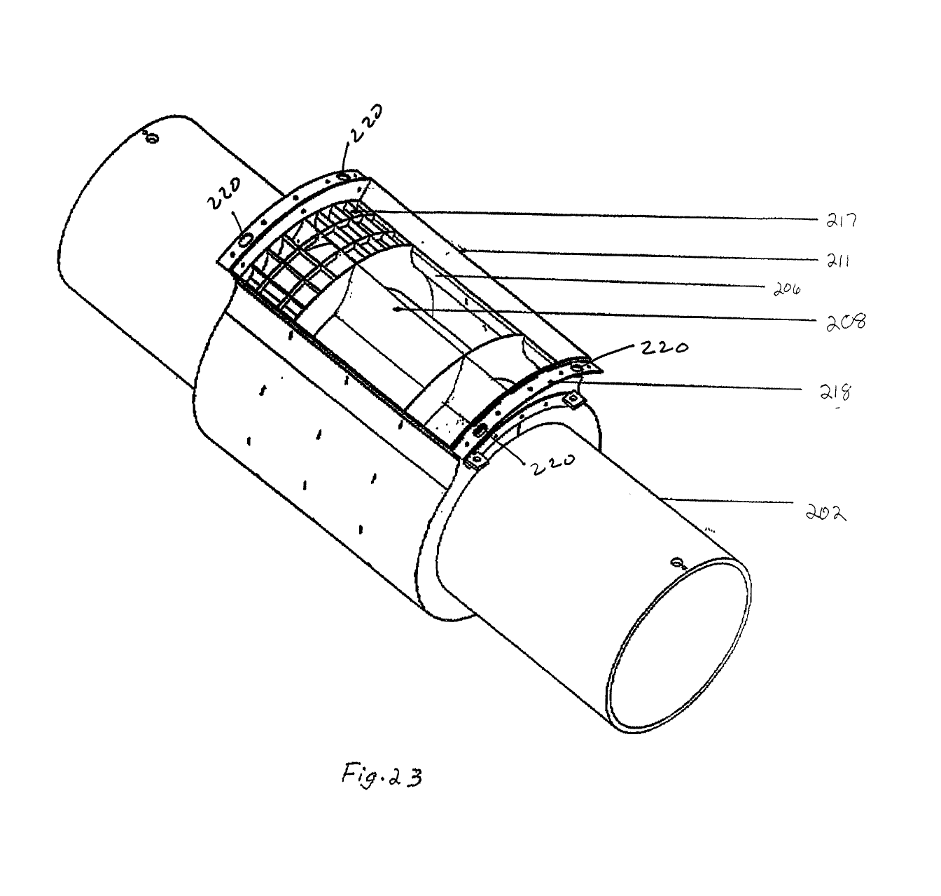

FIG. 21 shows a perspective view of the flow turning vanes 217 used in each compartment. Rails 227 are connected to leading edges of the flow turning vanes 217 to hold the flow turning vanes 217 together. The flow turning vanes 217 are then placed on the top partition 208 as best seen in FIG. 23. Once the flow turning vanes are placed on the top partition 208, the downstream edges of the flow turning vanes 227 are suspended in the annular channel between the inner tube 202 and the vacuum shell 206. By altering the distance between the downstream edges the airflow speed may be altered over the entire surface covered by the vanes 217.

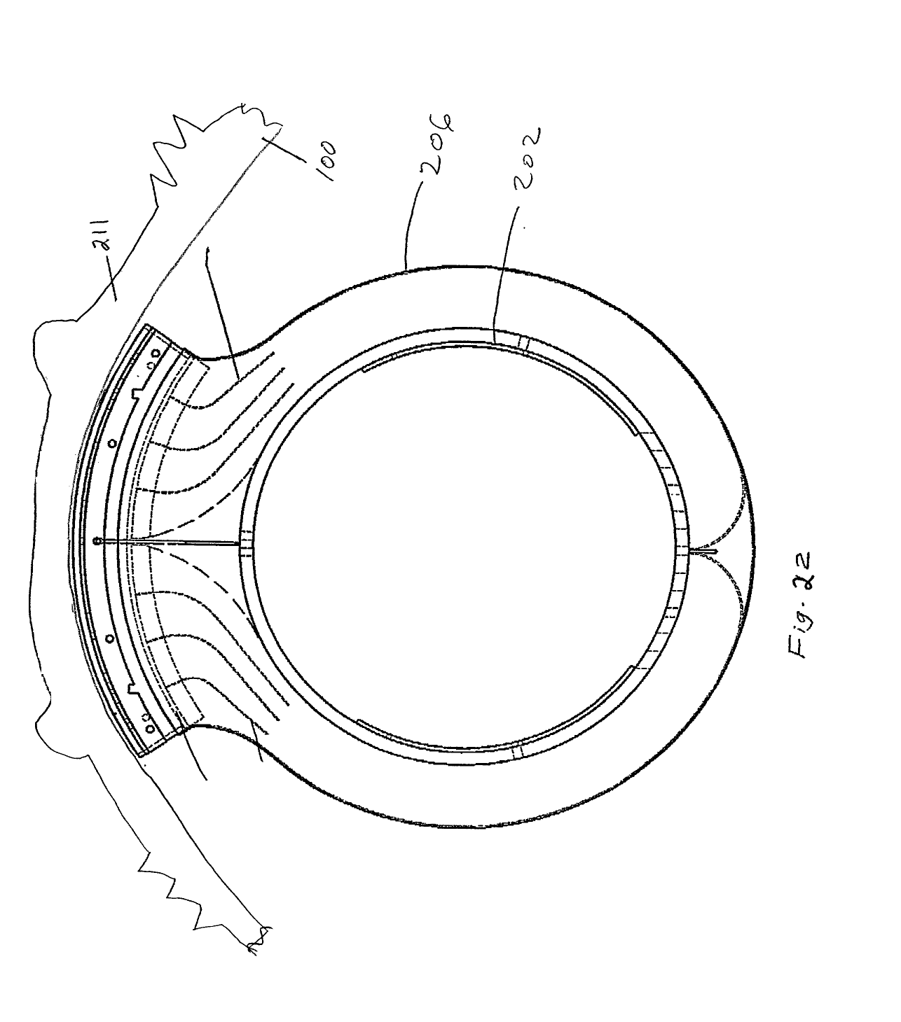

FIG. 22 is a side view of the inner tube 202 and the vacuum shell 206 which shows the position of the flow turning vanes 217 in the annular channel between the inner tube 202 and the vacuum shell 206. FIG. 22 also shows the relationship between the manifold 200 and the drum 100. Note, only a section of the drum 100 is shown in FIG. 22.

FIG. 23 is a perspective view of two sets of the vanes 217 installed in two of the compartments of the manifold 200 and FIG. 24 is an exploded view. Vanes 217 can be used in all, some, or none, of the compartments and can be of similar or different number and configuration, depending on the particular application and desired results. In the assembly, the flow turning vanes 217 and rails 227 are placed on the top partition 208. Then the frame 211 is mounted to the vacuum shell 206. Brackets 218 are then screwed on to the vacuum shell 206 to constrain the frame 211. Screws 222 to attach the frame 211 to the vacuum shell 206 run through holes 220 in the brackets 218. Finally, an optional honeycomb panel 216 is placed inside the frame 211. The height of the honeycomb 216 relative to the turning vanes 217 can be adjusted.

The double arrangement of the inner tube 202 within the vacuum shell 206, coupled with the flow turning vanes 217 and gate valves 210, are used to provide tailored air flow on the honeycomb panel 216, and accordingly through the drum 100, in both machine direction and cross direction. The double arrangement of the inner tube 202 within the vacuum shell 206, coupled with the turning vanes 217 also provides a method for redirecting airflow from a radial to an axial direction efficiently.

Variations, modifications, and other implementations of what is described herein will occur to those of ordinary skill in the art without departing from the spirit and the scope of the invention as claimed. For example, the manifold may be subdivided into greater or fewer than eight compartments and the compartments need not be the same size. Similarly, the number of valves and ports, as well as the configuration and orientation of the valves and ports need not be the same as disclosed herein.

Accordingly, the invention is to be defined not by the preceding illustrative description, but instead by the following claims.

1. A manifold spanning a sector of a drum across at least a portion of a width thereof, the manifold comprising at least two chambers independently regulatable with respect to at least one of pressure and flow.

2. The invention according to claim 1 wherein the manifold comprises an inner tube located inside of a shell, the shell further comprising a plate to prevent airflow from leaking around the inner tube.

3. The invention according to claim 2 wherein the inner tube comprises a plurality of ports to provide fluidic communication between the inner tube and the shell.

4. The invention according to claim 3 wherein the inner tube further comprises a plurality of valves in communication with the plurality of ports to regulate at least one of pressure in and flow through the manifold.

5. The invention according to claim 2 wherein the shell further comprises a frame forming an aperture.

6. The invention according to claim 5 further comprising a honeycomb panel disposed within the frame aperture.

7. The invention according to claim 5 further comprising at least one flow turning vane disposed between the inner tube and the frame aperture.

8. The invention according to claim 2 wherein the shell further comprises at least one partition thereby defining the at least two independently regulatable chambers.

9. A drum for forming non-woven articles, the drum comprising:
a generally tubular honeycomb member having an outer surface forming a contour; and
a manifold spanning a sector on the drum across a width therefore, the manifold subdivided into at least two chambers independently regulatable with respect to pressure.

10. The invention according to claim 9 wherein the drum further comprises a microporous layer covering at least a portion of the contour.

11. The invention according to claim 9 further comprising a frame for rotatably supporting the drum.

12. The invention according to claim 9 wherein the manifold comprises an inner tube located inside of a shell, the shell further comprising a plate to prevent airflow from leaking around the inner tube.

13. The invention according to claim 12 wherein the inner tube comprises a plurality of ports to provide fluidic communication between the inner tube and the shell.

14. The invention according to claim 13 wherein the inner tube further comprises a plurality of valves in communication with the plurality of ports to regulate at least one of pressure in and flow through the manifold.

15. The invention according to claim 12 wherein the shell further comprises a frame forming an aperture.

16. The invention according to claim 15 further comprising a honeycomb panel disposed within the frame aperture.

17. The invention according to claim 15 further comprising at least one flow turning vane disposed between the inner tube and the frame aperture.

18. The invention according to claim 12 wherein the shell further comprises at least one partition thereby defining the at least two independently regulatable chambers.

19. A method of independently regulating at least one of pressure and flow spanning a sector of a drum across at least a portion of a width thereof, the method comprising:
providing a drum comprising a manifold spanning a sector of the drum across at least a portion of a width thereof, the manifold subdivided into at least two chambers independently regulatable with respect to at least one of pressure and flow; and
applying a pressure to the manifold to achieve at least one of a desired pressure and flow profile across the sector of the drum.

20. The method of claim 19 wherein the pressure applied is a negative pressure.

21. The method of claim 19 wherein the pressure applied is a positive pressure.

22. The method according to claim 19 wherein the manifold comprises an inner tube located inside of a shell, the shell further comprising a plate to prevent airflow from leaking around the inner tube.

23. The method according to claim 22 wherein the inner tube comprises a plurality of ports to provide fluidic communication between the inner tube and the shell.

24. The method according to claim 23 wherein the inner tube further comprises a plurality of valves in communication with the plurality of ports to regulate at least one of pressure in and flow through the manifold.

25. The method according to claim 22 wherein the shell further comprises a frame forming an aperture

26. The method according to claim 25 wherein the shell further comprises a honeycomb panel disposed within the frame aperture.

27. The method according to claim 25 wherein the shell further comprises at least one flow turning vane disposed between the inner tube and the frame aperature.

28. The method according to claim 22 wherein the shell further comprises at least one partition thereby defining the at least two independently regulatable chambers.

29. A method of forming a non-woven article comprising the steps of:
providing a drum comprising:
a generally tubular honeycomb member having an outer surface forming a contour; and
a manifold spanning a sector of the drum across at least a portion of a width thereof, the manifold subdivided into at least two chambers independently regulatable with respect to at least one of pressure and flow;
applying pressure to the manifold;
depositing solidifying filaments on the outer surface to form a non-woven fibrous material substantially matching at least a portion of the contour; and
removing the fiberous material from the drum.

30. The method according to claim 29 wherein the drum further comprises a microporous layer covering at least a portion of the contour.

31. The method according to claim 29 wherein the pressure applied to the manifold is a negative pressure to conform the solidifying elements to the contour.

32. The method according to claim 29 wherein the pressure applied to the manifold is a positive pressure to facilitate removing the fibrous material from the drum.

33. A non-woven article produced according to the method of claim 29.
